(19) United States
(12) Patent Application Publication
(10) Pub. No.: US 2024/0201369 A1
(43) Pub. Date: Jun. 20, 2024

(54) METHOD OF PRE-PROCESSING ACOUSTIC SIGNALS RECEIVED FROM AN ENSONIFIED REGION OF AN UNDERWATER ENVIRONMENT

(71) Applicant: Wavefront Systems Limited, Yeovil, Somerset (GB)

(72) Inventor: Robert CROOK, Castle Cary (GB)

(73) Assignee: Wavefront Systems Limited, Yeovil, Somerset (GB)

(21) Appl. No.: 18/557,156

(22) PCT Filed: Apr. 25, 2022
(86) PCT No.: PCT/EP2022/060875

§ 371 Date: Oct. 25, 2023

(30) Foreign Application Priority Data
Apr. 26, 2021 (GB) 2105948.0

(51) Int. Cl. G01S 15/66; G01S 7/527; G01S 7/53; G01S 15/87

(52) U.S. Cl. CPC G01S 15/66; G01S 7/527; G01S 7/53; G01S 15/87

(57) ABSTRACT

A method of pre-processing acoustic signals received from an ensonified region (104) of an underwater environment (102) for passive detection of an object (106, 108) in the underwater environment (102). The method comprises generating (404) an acoustic B-scan (500) in respect of a predetermined time frame, and selecting (406) a temporal portion (502) of the acoustic B-scan (500) in accordance with a predetermined selection criterion. The method also comprises compressing (408) the selected temporal portion (502) of the acoustic B-scan (500) to provide a compressed acoustic B-scan (510), and applying (410) a B-scan background mask (512) to the compressed acoustic B-scan (510) to suppress any historic reflectivity samples of the compressed acoustic B-scan (510) and to provide an extant compressed acoustic B-scan (524), A dynamic range of the extant compressed acoustic B-scan (524, 600, 602, 604) is then suppressed (412).

### CROSS-REFERENCE TO RELATED APPLICATION(S)

This application is the National Phase under 35 U.S.C. § 371 of PCT International Application No. PCT/EP2022/060875, which has an international filing date of Apr. 25, 2022, and which claims priority to Great Britain Application No. 2105948.0, filed Apr. 26, 2021, the entire contents of each of which are incorporated herein by reference.

### FIELD

The present invention relates to a method of pre-processing acoustic signals received from an ensonified region of an underwater environment, the method being of the type that, for example, is used for passive detection of an object in the region of the underwater environment.

### BACKGROUND

In recent years, increasing effort has been devoted to securing maritime assets against the actions of terrorists and saboteurs. Above-water surveillance and access control is a crucial part of this task and can be addressed through a number of conventional technologies such as Close-Circuit Television (CCTV), Forward Looking Infra-Red (FLIR) systems, radar and swipe card access systems. Underwater security has however, until now, been acknowledged as the weakest link in the defence of ships, harbours and on-shore facilities.

For example, it is desirable to detect reliably underwater “targets” in an acoustic environment of a harbour. To achieve this, an entrance of the harbour can be monitored. Moreover, under the International Ship and Port Facility Security Code (ISPS code), it is necessary to ensure protection against foreseeable events and so monitoring of a particular underwater security zone is also desirable. Additionally, naval vessels at anchor in overseas ports, cruise liners in harbours and super-yachts moored off a coast, are all examples of specific assets that require protection from intruders.

An increase in threats of insurgency, vandalism and/or criminal activity extends not only to ports and military assets, but also to oil and gas installations, whether coastal or offshore. As such, these installations also need protection from intruders.

The Sentinel Intruder Detection Sonar (IDS) system, available from Sonardyne International Limited, is a known underwater surveillance system providing protection for strategic and high value marine assets, including oil and gas installations, power stations, ports and harbours, as well as luxury and naval vessels. The Sentinel IDS® system comprises, inter alia, multiple so-called sonar heads capable of processing acoustic signals in respect of hundreds of receiver channels per sonar head. The acoustic channel data received is sampled, pulse compressed and beamformed to produce directional beams data frames known as ‘B-scans’ before being processed further to track underwater intruders, for example Self-Contained Underwater Breathing Apparatus (SCUBA), closed-circuit divers, submarines, swimmers, surface craft and Autonomous Underwater Vehicle (AUV) drones. These “contacts” detected as a result of the processing are displayed in real-time in a tactically relevant manner via a user interface. This system is an active system in that the surrounding water has to be ensonified to detect and track acoustic energy reflected by said contacts.

Active detection and tracking systems have the advantage that since they do not rely on the often weak contact acoustic emissions for detection and tracking, they are therefore able to operate effectively in noisy underwater environments such as busy ports and harbours. Such systems achieve high target Signal-to-Noise Ratios (SNRs) in these scenarios by being designed to operate at advantageous frequencies that are selected for maximising target echo returns whilst minimising receiver background noise. State-of-the-art projector/receiver multi-channel transducers array designs, involving large (multi-wavelength) apertures in conjunction with appropriate signal processing, provide high receiver spatial processing gain, essential in allowing the active detection and tracking system the ability to discriminate potentially weaker echo returns in one direction from stronger returns in another. Furthermore, active systems are capable of localising spatially a contact return in both range and bearing from a single sonar head.

This is in contrast to passive detection and tracking systems, which typically struggle to detect and track weakly emitting contacts in such noisy underwater environments owing to their lack of spatial processing gain. In this regard, such systems typically comprise a single hydrophone or small, sparse ‘nodal’ collections of hydrophones rather than fully populated receiver arrays and are unable to control fully the choice of receiver frequency bandwidth, because this is driven by the nature of the emissions by the contacts. Furthermore, passive systems cannot spatially localise a contact return in both range and bearing from a single hydrophone node and must instead rely on multiple spatially distributed nodes for such localisation necessary for tracking. This considerably impacts on the practicality of installation in working environments, for example command and control, and/or cabling.

A further disadvantage of passive detection and tracking systems is that they struggle to distinguish weak passive contacts of interest, for example drone intrusion, whilst simultaneously listening to far louder noise sources of no tactical interest, for example noise associated with general harbour activity and/or vessel manoeuvring, owing to the high dynamic range variations associated with the different kinds of contacts. This tends to create copious, spurious detections in the presence of sources of high amplitude acoustic emissions, for example ships in harbours, sometimes to the extent of saturation.

However, despite these issues, passive detection and tracking systems have some unique advantages over active detection and tracking systems. Some contacts are not necessarily sufficiently reflective of emitted acoustic energy incident upon them to enable them to be detected, but may nevertheless be ‘visible’ to passive detection systems owing to their own low-level acoustic emissions. Also, there is potential information in these low-level acoustic emissions that could enable some form of target classification, for example whether a detected target is or is not a threat, based on successful passive detection and tracking.

It is known to deploy two independent detection systems: a multi-node passive sonar detection and tracking system with an active sonar detection and tracking system operating in the same region. However, such systems suffer from a number of disadvantages. As the sonar heads of such systems are separate and independent, it is necessary to provide an additional level of processing in order to geographically and temporally co-register tracking results from both the active detection system and the passive detection system. Indeed, even with the provision of co-registration processing, the resulting co-registered output of the combined detection system can suffer from absolute positioning and orientation errors. Additionally, the acoustic emissions of the active sonar detection and tracking system generates a background level of acoustic energy that typically masks the lower amplitude and hence more subtle acoustic emissions from less acoustically reflective contacts, thereby presenting detection problems for the passive sonar detection and tracking system. This issue is often present even if the active and passive sonar systems have nominally separated operating bandwidths due to interference caused by out-of-band transmission energy ‘leakage’ from the active system or inadequate/imperfect bandwidth filtering in the signal processing of the passive system.

As such, the combined system effectively needs to switch periodically between the active detection and tracking subsystem and the passive detection and tracking subsystem to mitigate polluting detection channels of the passive detection and tracking system with reverberant energy from the active detection and tracking system. However, such switching presents challenges in maintaining coherent tracks of objects of interest and developing sufficiently intelligent control logic capable of deciding when to switch between the active detection and tracking system and the passive detection and tracking system. Also, where both active and passive detection and tracking systems are used independently but in combination, non-overlapping operating bandwidths have to be employed, creating the additional disadvantage to both systems of having to reduce bandwidth and/or shift operating frequencies to non-optimal regions of the acoustic spectrum. Any such reduction in operating bandwidth is undesirable: it will limit the signal energy/information content of a passive system, whilst degrading the range resolution and reverberation suppression of an active system.

It is therefore desirable to perform active as well as passive detection and tracking of underwater targets substantially contemporaneously over the same time period and over identical or overlapping bandwidths. It is also desirable for the active/passive sensor to be co-located and thus share an identical spatial location.

### SUMMARY

According to a first aspect of the present invention, there is provided a method of pre-processing acoustic signals received from an ensonified region of an underwater environment for passive detection of an object in the underwater environment, the method comprising: generating an acoustic B-scan in respect of a predetermined time frame; selecting a temporal portion of the acoustic B-scan in accordance with a predetermined selection criterion; compressing the selected temporal portion of the acoustic B-scan to provide a compressed acoustic B-scan; applying a B-scan background mask to the compressed acoustic B-scan to suppress any historic reflectivity samples of the compressed acoustic B-scan and to provide an extant compressed acoustic B-scan; and suppressing a dynamic range of the extant compressed acoustic B-scan.

The acoustic B-scan may comprise acoustic sample data in respect of a plurality of acoustic receive beams. The plurality of acoustic receive beams may respectively correspond to a plurality of hydrophone array element signals. The acoustic sample data may comprise a plurality of acoustic sample data in respect of each acoustic receive beam of the plurality of acoustic receive beams. The plurality of acoustic receive beams may comprise a plurality of sequential acoustic sample data.

Selecting the temporal portion of the acoustic B-scan may further comprise: selecting the temporal portion of the acoustic B-scan in respect of a proportion of the predetermined time frame.

The predetermined scan time may extend between a temporally soonest time and a temporally latest time; and the proportion of the predetermined time frame may extend from an intermediate time to the temporally latest time; the intermediate time may be located between the temporally soonest and latest times.

The selected temporal portion of the acoustic B-scan may comprise reverberation energy and non-reverberation energy.

The acoustic B-scan may comprise reverberant energy and non-reverberant energy; the selected temporal portion of the acoustic B-scan may correspond to a range in space proximal an end of a maximum reporting range in respect of the reverberant energy.

The selected temporal portion of the acoustic B-scan may comprise a number of sequentially latter samples with respect to a duration of the predetermined time frame.

The method may further comprise storing a temporal indication corresponding to the proportion of the predetermined time frame.

Compressing the selected temporal portion of the acoustic B-scan may further comprise: selecting sets of samples in respect of each bearing of the selected temporal portion of the acoustic B-scan and respectively averaging each set of the selected sets of samples.

The B-scan background mask may be a reference map of the region of the underwater environment.

The method may further comprise: repeatedly updating the B-scan background mask from historic temporally filtered acoustic B-scans relating to the region of the underwater environment.

The B-scan background mask may be a record of an exponentially integrated acoustic B-scan history; the method may further comprise: constructing the B-scan background mask using consecutively windowed and compressed acoustic B-scans accumulated over an integration period of time.

The integration period of time may be configurable.

Compressing the selected temporal portion of the acoustic B-scan may further comprise compressing the selected temporal portion of the acoustic B-scan according to a predetermined compression ratio; the predetermined compression ratio may be configurable.

Applying the B-scan background mask to the compressed acoustic B-scan may comprise normalising the compressed acoustic B-scan.

Suppressing the dynamic range of the extant compressed acoustic B-scan may further comprise: clipping the extant compressed acoustic B-scan with respect to a predetermined clipping level.

The method may further comprise: a predetermined detection level for passive detection of an object in the region of the underwater environment; and setting the predetermined clipping level above the predetermined detection level.

The predetermined detection level may be between 0.5 decibels and 10 decibels above a normalised amplitude level. The predetermined clipping level may be set between about 0.5 decibels and 10 decibels above the predetermined detection level, for example between about 1 decibel and about 5 decibels, such as about 3 decibels.

Applying the B-scan background mask to the compressed acoustic B-scan may further comprise: applying a ratio function to the compressed acoustic B-scan and corresponding reflectivity data of the B-scan background mask.

The ratio function may comprise calculating a quotient of the compressed acoustic B-scan and the B-scan background mask. The compressed acoustic B-scan may be in respect of a plurality of acoustic receiver beams; the compressed acoustic B-scan may comprise a plurality of compressed acoustic sample data in respect of each acoustic receiver beam of the plurality of acoustic receiver beams. The B-scan background mask may be in respect of a plurality of acoustic receiver beams; the B-scan background mask may comprise a plurality of accumulated historic sample data in respect of each acoustic receiver beam of the plurality of acoustic receiver beams. The calculation of the quotient may yield the extant compressed acoustic B-scan. The extant compressed acoustic B-scan may be in respect of a plurality of acoustic receiver beams; the extant compressed acoustic B-scan may comprise a plurality of extant compressed acoustic sample data in respect of each acoustic receiver beam of the plurality of acoustic receiver beams.

The method may further comprise: using a first transducer head to pre-process acoustic signals and provide the extant compressed acoustic B-scan comprising a first transient signal in respect of a first beam angle, and a second transducer head to pre-process the acoustic signals independently and provide another extant compressed acoustic B-scan comprising a second transient signal in respect of a second beam angle; and providing a processing resource to calculate a correlation between the first transient signal and the second transient signal and to triangulate a position in space in respect of the first and second transient signals in response to a high correlation between the first and second transient signals using the first and second bearings.

According to a second aspect of the present invention, there is provided a method of passive acoustic detection of an object in an ensonified region of an underwater environment, the method comprising: pre-processing acoustic signals received from the ensonified region of the underwater environment using the method of pre-processing as set forth above in relation to the first aspect of the present invention; and analysing an extant A-scan in respect of a beam of the extant compressed acoustic B-scan of suppressed dynamic range to determine whether the extant A-scan relates to a source of non-reverberant energy of interest.

Analysing the extant A-scan may comprise integrating the extant A-scan.

According to a third aspect of the present invention, there is provided a method of performing active and passive acoustic detection substantially contemporaneously in time in respect of a region of an underwater environment, the method comprising: ensonifying the region of the underwater environment; performing the method of passive acoustic detection as set forth above in relation to the second aspect of the present invention to detect the source of non-reverberant energy in the underwater environment; and performing active detection processing in respect of the acoustic B-scan generated for detecting a source of reverberant energy in the underwater environment of a predetermined category.

The method of passive detection and the active detection processing may operate in respect of at least partially overlapping receive signal bandwidths.

The method of passive detection and the active detection processing may operate in respect of substantially same receive signal bandwidths.

The method of passive detection and the active detection processing may operate in respect of separate receive signal bandwidths.

It is thus possible to provide a method of pre-processing acoustic signals and a method of filtering an acoustic B-scan that are capable of providing significantly enhanced passive detection and tracking by retaining all the spatial processing gains associated with an active sonar detection and tracking system. Additionally, tracking between the active and passive sub-systems is spatially co-registered. Furthermore, the method overcomes the need to switch between the passive and active subsystems. It therefore follows that the contemporaneous use of the active and passive subsystems is possible, and also without adversely affecting the performance of the active subsystem through use of common operating bandwidths for both subsystems. The ability to complement active detection and tracking with passive detection and tracking using common hydrophone hardware enables tracking of low reflectivity targets of interest, and indeed targets that are moving very slowly or are stationary. The addition of the ability to track targets passively also enables some targets that are obscured from direct ensonification to be tracked. Also, supplementing active tracking and detection with passive detection and tracking enhances so-called kinematic based classification of active tracks with signature based passive classification. Where more than one sonar head is employed in tandem for passive detection and tracking, further positional information can be discerned, for example to supplement positional information using the active tracking subsystem.

### BRIEF DESCRIPTION OF THE DRAWINGS

At least one embodiment of the invention will now be described, by way of example only, with reference to the accompanying drawings, in which:

FIG. 1 is a schematic diagram of an underwater environment that is being monitored by an underwater sonar monitoring system constituting an embodiment of the invention;

FIG. 2 is a schematic diagram of the underwater sonar monitoring system of FIG. 1 in greater detail;

FIG. 3 is a schematic diagram of a processor platform of FIG. 2 in greater detail;

FIG. 4 is a high-level block diagram of functional elements supported by the underwater sonar system of FIGS. 1, 2 and 3;

FIG. 5 is a block diagram of processing elements supporting the high-level functional blocks of FIG. 4;

FIG. 6 is a block diagram of a processing chain supported by a receiver processing unit and a signal processing unit of FIG. 5;

FIG. 7 is a block diagram of a passive processing chain supported by the passive signal process unit of FIG. 6;

FIG. 8 is a flow diagram of a method of passively detecting a source of acoustic energy emissions constituting another embodiment of the invention;

FIG. 9 is a schematic diagram of an acoustic B-scan used by the passive signal process unit of FIG. 5;

FIG. 10 is a schematic diagram of sample selection performed in relation to the acoustic B-scan of FIG. 9;

FIG. 11 is a schematic diagram of sample compression performed in relation to a selection of FIG. 10 in respect of the B-scan of FIG. 9;

FIG. 12 is a schematic diagram of a reference map in respect of the underwater environment of FIG. 1;

FIG. 13 is a schematic diagram of the compressed B-scan of FIG. 11 in greater detail; and

FIG. 14 is a schematic diagram of an output of a rationing function using the reference map of FIG. 12 and the compressed B-scan of FIG. 13;

FIGS. 15(a) to (c) are amplitude scans (A-scans) in respect of three beams of the extant compressed acoustic B-scan of FIG. 14;

FIGS. 16(a) to (c) are the A-scans of FIGS. 15(a) to (c), respectively, in greater detail;

FIG. 17 is a schematic diagram of calculated beam scores generated from A-scans, for example A-scans of FIG. 16;

FIG. 18 is a flow diagram of a method of filtering scores for passive detection constituting a further embodiment of the invention; and

FIG. 19 is a schematic diagram of another underwater sonar monitoring system employing more than one hydrophone head.

### DETAILED DESCRIPTION OF THE EXAMPLE EMBODIMENTS

Throughout the following description identical reference numerals will be used to identify like parts.

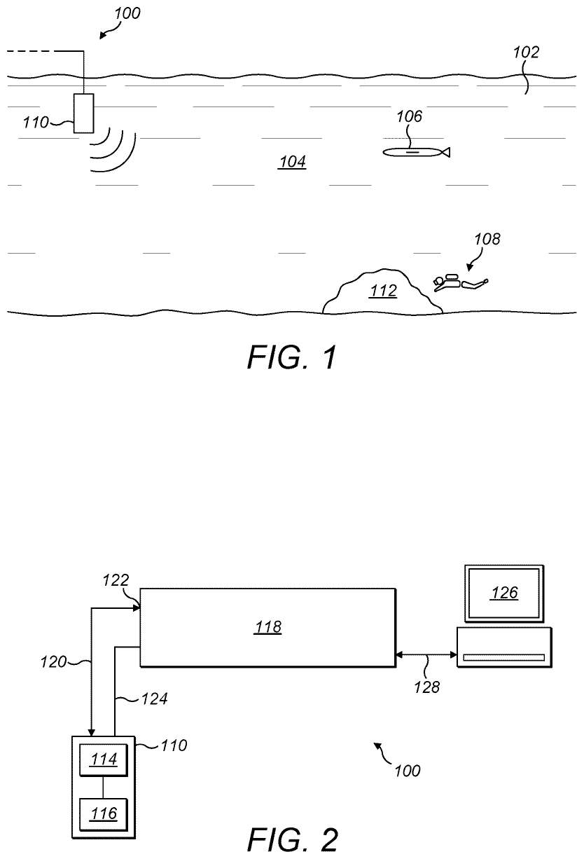

Referring to FIG. 1, a combined active and passive underwater sonar monitoring system, for example an underwater intruder detection system 100 is immersed in an underwater environment 102. In this example, purely to assist in the understanding of operation of the underwater intruder detection system 100, a region to be ensonified 104 of the underwater environment 102 comprises an autonomous underwater vehicle (AUV) 106, and a SCUBA diver 108 obscured from a projector field of view of a sonar head unit 110 of the underwater intruder detection system 100 by a natural underwater clutter feature, for example a large rock formation 112. In each case, the targets of interest 106, 108 may exist at a range from the sonar head unit 100 which is co-incident with the range to the clutter 112 in such a manner as to lower their respective Signal-to-Background Ratios (SBRs) for active detection. The sonar head unit 110 is, for example a Sentinel™ sonar head, available from Sonardyne International Limited, UK.

Turning to FIG. 2, in this example, the sonar head 110 comprises a transceiver array to provide a combined transmit and receive array and associated signal processing circuitry. The sonar head 110 has a wide bandwidth transmission capability, having a central frequency of about 70 kHz and a bandwidth in excess of about 20 kHz. The sonar head 110 comprises eight separate 45° transmit sectors, which are individually addressable, allowing any segment to be disabled to reduced nuisance acoustic returns from close objects, such as harbour walls or jetties. The transmitters of the sonar head 110 are programmable and supplied with a number of different selectable frequency modulated Doppler tolerant pulse shapes.

In this example, a transducer array of the transceiver array is a compact 1:3 piezo-composite transducer array having 128 separately wired channel elements, which can be used to form 256, equally spaced, receive beams, each with a 1.4° angular spacing.

As mentioned above, the sonar head 110 also comprises signal processing circuitry (not shown) to digitise, mix down to baseband, filter, multiplex and transfer the signals received by the transducer array. The sonar head 110 also comprises attitude, heading reference and position sensors 114 to monitor orientation and position of the sonar head 110 and constitutes a source of orientation and position data in respect of receipt of sonar reflections. A data enrichment module 116 of the sonar head 110 is capable of enriching acoustic reflectivity data with attitude, heading and position information obtained from the attitude, heading reference and position sensors 114.

The sonar head 110 is operably coupled to a processor platform unit 118 via either a 75 m copper or 300 m or greater fibre-optic cable 120 coupled to an input/output port 122. A power supply cable 124 also couples the sonar head 110 to the processor platform unit 118. The processor platform unit 118 is, in this example, a Sentinel™ processor platform available from Sonardyne International Limited, but adapted to operate in accordance with the method set forth herein.

The processor platform unit 118 is operably coupled to a workstation 126, for example a computing apparatus, such as a first Personal Computer (PC), via any suitable data communications link, for example an Ethernet link 128. The workstation 126 supports the execution of software, for example an operator console module, which provides a tactical-style display. The workstation 126 is a Sentinel™ command workstation, available from Sonardyne International Limited.

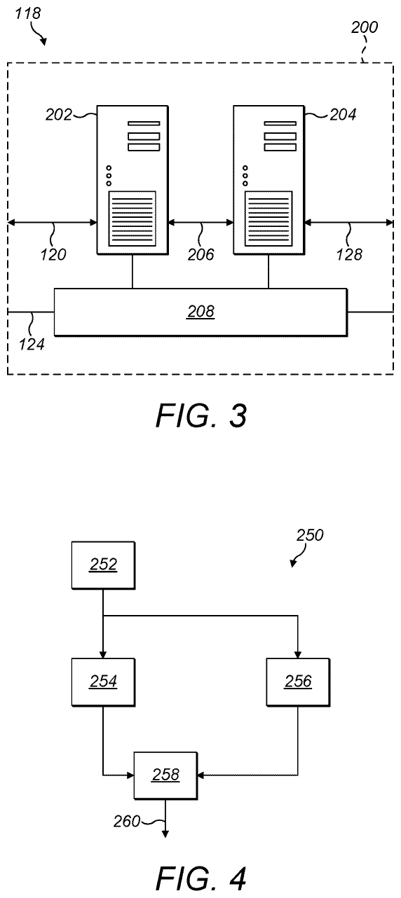

Turning to FIG. 3, the processor platform unit 118 comprises a rugged housing, for example a case 200, comprising a processing resource, for example a computing apparatus, such as a second high-performance PC 202 operably coupled to a third high-performance PC 204 via, for example, a communications link, such as another Ethernet connection 206. In this example, the third PC 204 is operably coupled to the workstation 126 via the Ethernet link 128, and the second PC 202 is operably coupled to the sonar head 110 via the cable 120 and a suitable interface card (not shown), depending upon whether an electrical or optical connection is made to the sonar head 110.

Although, in this example, the first, second and third PCs 126, 202, 204 are connected using direct Ethernet connections, the skilled person will appreciate that a communications network, for example an Ethernet network, can be employed in order to interconnect the first, second and third PCs 126, 202, 204 as desired.

In order to power the intruder detection system 100, at least in respect of the processor platform unit 118 and the sonar head 110, the processor platform unit 118 comprises a power distribution unit 208. The power distribution unit 208 comprises, for example, batteries in order to power the second PC 202, the third PC 204 and the sonar head 110. Of course, if a vessel-based power supply is available, the power distribution unit 208 is capable of deriving and delivering electrical power from this source. In this example, the power distribution unit 208 is operably coupled to the sonar head 110 via the power supply cable 124. However, the skilled person will appreciate that the power distribution unit 208 can be used also to power the workstation 126 or simply to power the second and third PCs 202, 204. In the event that the power distribution unit 208 is not used to power the sonar head 110, the sonar head 110 can be provided with its own power supply.

Referring to FIG. 4, the second and third PCs 202, 204 cooperate to support initial signal processing 252 by processing data received from acoustic hydrophone elements using pulse compression and beam-forming. The results of the initial signal processing 252 are fed into an active detection and tracking processing chain 254 and a passive detection and tracking processing chain 256, the active and passive detection and tracking processing chains 254, 256 providing data that are then subsequently filtered 258 to yield a classified track output 260. The classified track output 260 is subsequently used by other downstream processing functionality, for example to present classified tracks.

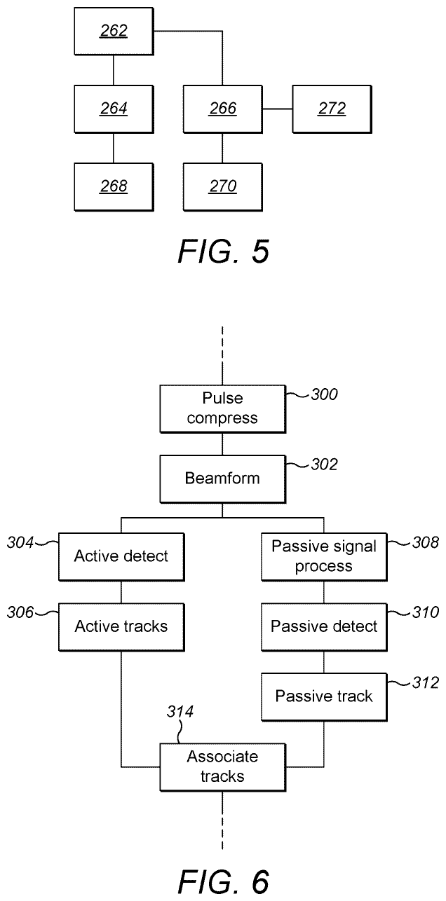

Turning to FIG. 5, in order to support the above-described high-level functionality, the second and third PCs 202, 204 cooperate to provide a control unit 262 operably coupled to a transmitter unit 264 and a receiver processing unit 266. The transmitter unit 264 is operably coupled to a logical projector array 268 of the transducer array of the sonar head 110 mentioned above. Similarly, the receiver processing unit 266 is operably coupled to a logical receive array 270 of the transducer array of the sonar head 110. The receiver processing unit 266 is also operably coupled to a signal processing resource 272.

Referring to FIG. 6, the receiver processing unit 266 supports a pulse compression module 300 operably coupled to a beamforming module 302. The pulse compression and beamforming modules 300, 302 correspond to the initial signal processing 252 described above in relation to FIG. 4. In this regard, the signal processing resource 272 of FIG. 5 supports an active detection module 304 operably coupled to the beamforming module 302, the active detection module 304 also being operably coupled to an active tracking module 306. In this example, the active detection module 304 and the active tracking module 306 are in the active detection and tracking processing chain 254 of FIG. 4. The signal processing resource 272 of FIG. 5 also supports a passive signal processing module 308 operably coupled to the beamforming module 302. The passive signal processing module 308 is also operably coupled to a passive detection module 310, the passive detection module 310 being operably coupled to a passive tracking module 312. In this example, the passive signal processing module 308, the passive detection module 310 and the passive tracking module 312 are in the passive detection and tracking processing chain 256 of FIG. 4. The active tracking module 306 and the passive tracking module 312 are both operably coupled to an association filter module 314 supported by the signal processing resource 272.

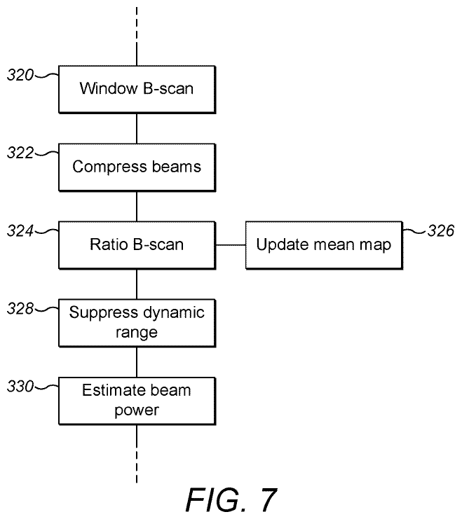

Turning to FIG. 7, the passive signal processing module 308 supports the following functional modules. A B-scan windowing module 320 is operably coupled to the beamforming module 302 and a beam compression module 322, the beam compression module 322 being operably coupled to a ratio function module 324. A reference map module 326 is operably coupled to the ratio function module 324 and the ratio function module 324 is also operably coupled to a dynamic range suppression module 328. The dynamic range suppression module 328 is operably coupled to a beam power estimation module 330.

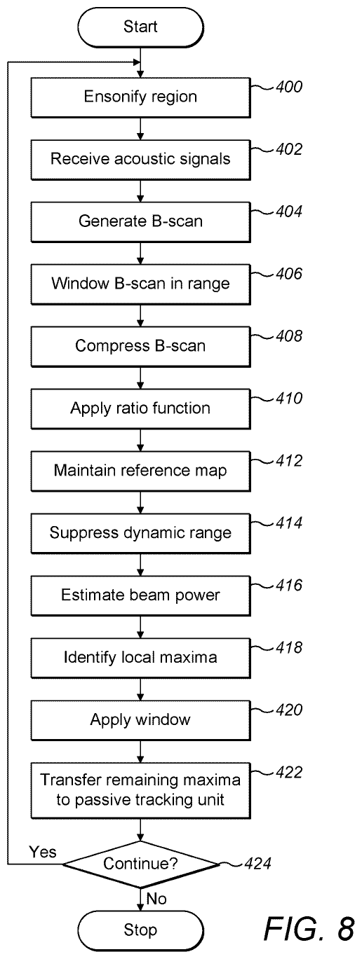

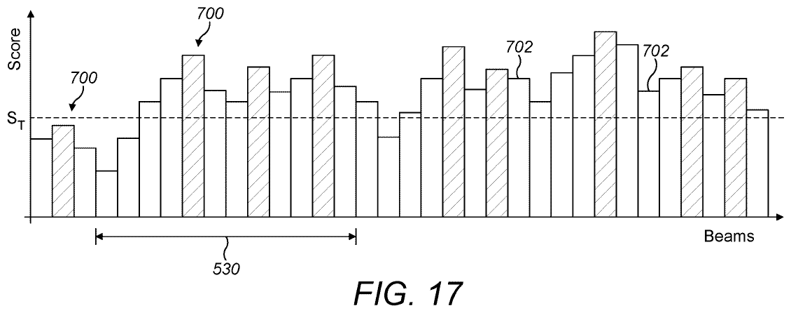

In operation (FIGS. 8 and 17), the active detection and tracking processing chain 254 serves to perform active detection and tracking of objects in the region to be ensonified 104 of the underwater environment 102. The performance of active detection and tracking using the sonar head 110 is known in the art and so, for the sake of conciseness of description, only salient aspects of the active detection and tracking processing chain 254 that are relevant to describing operation of the passive detection and tracking processing chain 256 or other system components will be described herein.

In this regard, the sonar head 110 is immersed in the underwater environment so as to submerge the sonar head 110 in the water in order to monitor the region to be ensonified 104. The processor platform unit 118 and the workstation 126 are then powered up. The workstation 126 loads and executes software to provide an operator of the system with graphical data and other information in accordance with the software provided by Sonardyne International Limited, appropriately modified also to provide passive contact detection and tracking information. Likewise, the processor platform unit 118 executes software in order to process acoustic reflectivity images and passive acoustic images in the manner described herein. Thereafter, the intruder detection system 100 starts monitoring the region to be ensonified 104 of the underwater environment 102 as follows.

The sonar head 110 ensonifies (Step 400) the region 104 of the underwater environment 102 and receives acoustic reflections, constituting reverberant energy, as a result of the ensonification, analogue data pertaining to the received acoustic reflections being provided by the logical receive array 270 to the receiver processing unit 166. In response to the received acoustic reflections arising from ensonification of the region 104, the active detection and tracking processing chain 254 generates active track data. However, in addition to reflecting objects, such as the large rock formation 112, the region 104 comprises less reflective objects or objects concealed by other objects either by propagation path obscuration or reduced Signal-to-Background Ratios (SBRs) and thus unable to reflect detectable acoustic signals as a result of this concealment, for example the AUV 106 and the SCUBA diver 108. These objects nevertheless emit acoustic energy that can be detected and tracked by the passive detection and tracking processing chain 256.

For both the active detection and tracking processing chain 254 and the passive detection and tracking processing chain 256, the receiver processing unit 266 receives (Step 402) the analogue acoustic signals obtained via the logical receive array 270 corresponding to N hydrophone elements of the transducer array of the sonar head 110. The analogue acoustic signals comprise both reverberant and non-reverberant energy, which is digitally sampled by the receiver processing unit 266 at a rate F samples per second where F is a sampling rate satisfying Nyquist's theory. In some embodiments, the digitisation process can include further signal conditioning steps, for example complex heterodyning, digital filtering and decimation to provide a signal output digitised at a reduced complex sample rate F₀ that is less than the Nyquist sampling rate but greater than the system bandwidth. In any event, the N channels of hydrophone element data are digitally sampled at a sampling rate over a period of time constituting a time frame. The time frame, T_{frame}, corresponds to a predetermined reporting range of the active detection and tracking processing chain 254. The sampling process yields a package of data corresponding to N channels of NT samples constituting a data frame. This process is repeated each time the active detection and tracking processing chain 254 ensonifies the region 104, and each data frame generated is provided to the signal processing resource 272.

The data frame is then received by the pulse compression module 300 and each channel of the N channels of the data frame is correlated with a digitised replica of a transmitted pulse used to ensonify the region 104, the digitised replica being the result of sampling the replica at the sampling frequency. The result of the correlation is the pulse compression of the N channels of the data frame, the pulse compressed data frame being passed to the beamforming module 302, which applies a spatial filtering operation to the data so as to form N_{B} focused beams in predetermined directions. In this example, the beams are uniformly spaced in angular direction around a full azimuth circle. The number of temporal samples corresponding to each of the N_{B} beams following processing by the beamforming module 302 is N_{S} about the same number of temporal samples contained by the data frame in respect of each of the N channels. The beamformed data set will be referred to hereafter as a B-scan frame (Step 404). The B-scan comprises a plurality of sets of samples respectively corresponding to a plurality of acoustic receiver beams. The nominal range scale associated with the B-scan frame is R_{S}, where in this example R_{S}=c/2×N_{S}/F₀ where c is the prevailing average speed of sound in the ensonified region 104.

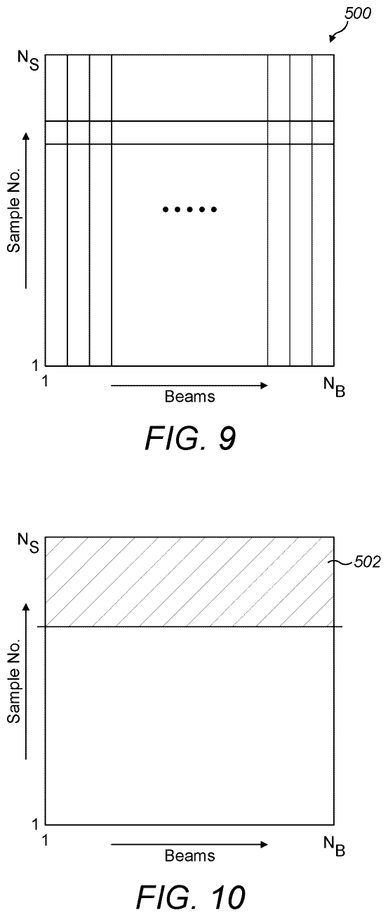

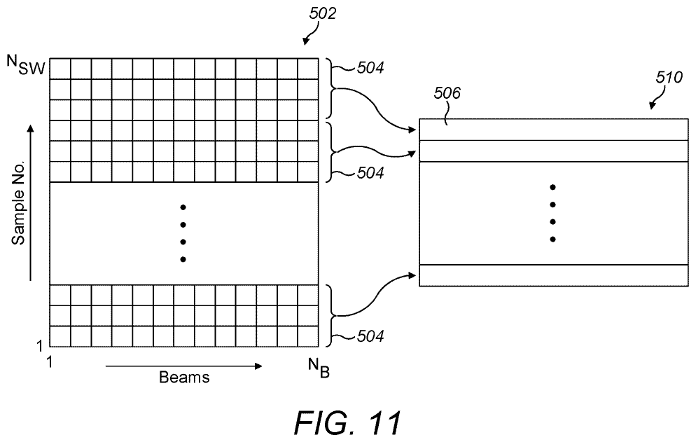

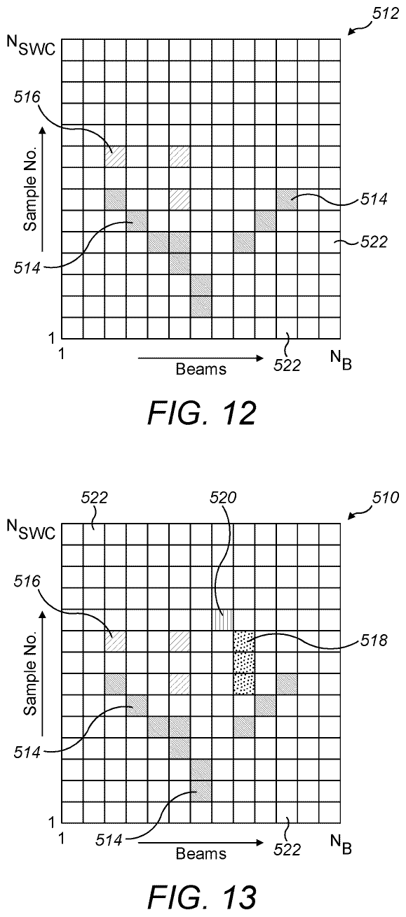

The B-scan frames generated are processed by the active detection module 304 according to any suitable known technique for active sonar detection of contacts. Referring to the passive detection and tracking processing chain 256, the passive signal processing unit 308 also receives the B-scan frame. Turning to FIG. 9, the B-scan frame 500 comprises a plurality of samples, N_{S}, in respect of each of a plurality of beams, N_{B}, of the logical receive array 270. Upon receipt of the B-scan frame 500 by the passive signal processing unit 308, the B-scan windowing module 320 (FIG. 7) performs a windowing operation (Step 406) on the B-scan frame 500 received, because target acoustic emissions must, in the context of a contemporaneous active and passive detection, be detected against a background of active reverberation energy. In this regard, it follows that the passive detection and tracking processing chain 256 can detect more reliably a certain level of acoustic emission against weaker active acoustic reflections from a relatively long range than against far stronger active acoustic reflections originating at closer ranges. In view of this principle, the passive detection of transient emissions is limited to an appropriately delayed fraction of the B-scan frame 500, in this example, referenced from the end of the B-scan frame 500. In this regard, the B-scan windowing module 320 selects (Step 406) a proportion of the B-scan frame 500 to leave a temporal portion 502 (FIG. 10) of the B-scan frame 500. The selected proportion can reside between about 50% and about 100% of the duration of the B-scan frame 500, for example between about 70% and about 100%, i.e. approximately the last 30% of the duration of the B-scan frame 500 as shown in FIG. 10, yielding a B-scan frame of N_{SW} samples. It should be appreciated that, in some circumstances, limiting the portion of the B-scan frame 500 can serve to enhance passive detection of transient emissions of a certain duration for a given detection threshold. It should be noted, however, that unlike active reflected target returns, these passively detected acoustic emissions are asynchronously detected with respect to the active transmit cycle since their arrival times at the sonar head 110 are a function of their position relative to the head and their absolute time of emission, and can therefore appear at varying sample numbers anywhere within the B-scan frame 500 even for an acoustic emitter at a fixed position relative to the sonar head 110 including one at a range beyond the nominal active range scale. Once the B-scan windowing module 320 has generated the temporal portion of the B-scan frame 502, the temporal portion of the B-scan frame 502 is provided to the beam compression module 322, which compresses (Step 408) the portion of the B-scan frame 502 selected to a B-scan frame of N_{SWC} samples. In this regard, and referring to FIG. 11, a predetermined sample grouping size is used to select sets of samples 504 in respect of each beam N_{B} of the temporal portion of the B-scan frame 502. In the example of FIG. 11, the predetermined sample grouping size is 3, but any other suitable sample grouping size can be employed. The sets of samples selected in respect of each beam, N_{B}, of the temporal portion of the B-scan frame 502 are sequential sets of samples, the samples of each set of samples 504 being averaged in respect of each beam, N_{B}, to yield a plurality of averaged samples 506 in respect of each beam, N_{B}. In this example, the average calculated is an arithmetic mean. However, other averaging and/or compression techniques can be employed, for example a peak-pick technique, a geometric mean or a median value. The beam compression module 322 therefore provides a compressed B-scan 510 to the ratio function module 324, the ratio function module 324 also accessing a reference map. In this regard, a reference map generation unit (not shown) supported by the signal processing resource 272 maintains the reference map 512 (FIG. 12) of the region 104 by receiving compressed B-scans 510 from the beam compression module 322 and exponentially integrating a B-scan history built up in relation to the region 104. An example of reference map generation in respect of active sonar detection is described in UK patent no. 2 523 561. An integration factor is associated with the maintenance of the reference map 512, which is configurable between 0 and 1, for example 0.01.

Prior to updating the reference map 512, as mentioned above, a ratio function is applied (Step 410) in respect of the compressed B-scan 510 (FIG. 13) to the reference map 512 (FIG. 12). In this example, the reference map 512 comprises high amplitude data points 514, typically as a result of acoustic reflections from infrastructure in the region 104, for example the rock formation 112. The compressed B-scan 510 also, in this example, comprises corresponding high amplitude data points 514. Both the reference map 512 and the compressed B-scan 510 also comprise medium amplitude data points 516 in respect of clutter features. In the examples set forth herein, so-called “clutter features” can be regarded as any feature of the environment that causes a detection amplitude elevated above a normalised amplitude level (mentioned in further detail hereinbelow) of unity, for example anything on the seafloor, but not the seafloor itself, such as rocks and rock formations. However, clutter features do not exclusively exist on the seafloor and can include, for example, wake trails. Low amplitude data points 518 are, in this example, absent from the reference map 512, but present in the compressed B-scan 510. Similarly, a new target return data point 520 features in the compressed B-scan 510, but not the reference map 512. The remaining data points in both the reference map 512 and the compressed B-scan 510 are mean return level data points 522 from reverberant noise.

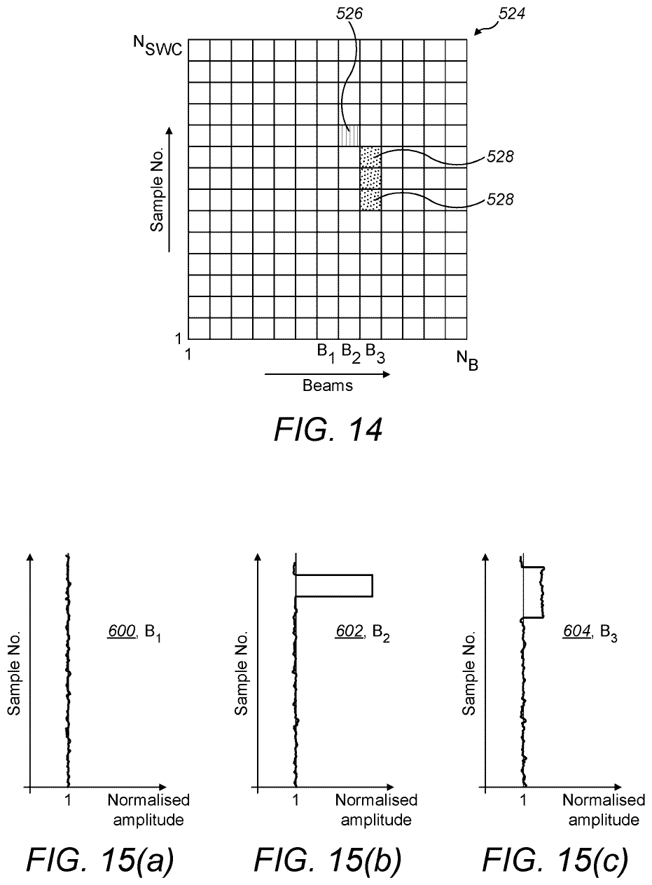

Application of the ratio function by the ratio function module 324 yields an extant compressed B-scan 524 (FIG. 14) comprising normalised amplitude data points, the application of the ratio function substantially eliminating ‘stationary’ data points from the compressed B-scan 510 corresponding to infrastructure, clutter and background reverberant noise whilst accentuating contacts which have moved into or within the field of view since the last reference map update (Step 412). As such, in this example, the extant compressed B-scan comprises a first extant data point 526 corresponding to the new target return 520 of the compressed B-scan 510 and second extant data points 528 corresponding to the low amplitude data points 518 of the compressed B-scan 510 representing the presence of a new transient emission.

Once the ratio function has been applied (Step 410), the signal processing unit 272 updates (Step 412) the reference map 512 with the data from the compressed B-scan 510.

The passive detection and tracking processing chain 256 is responsible for correlating generally low amplitude level, temporally extended acoustic emissions within beams with the presence of emitting targets and so it is important to prevent high amplitude, spatially localised, returns from reverberant energy from reflecting targets from dominating the passive detection process and thus limit the ability of irrelevant beams leading to false detections and subsequently tracking thereof. Consequently, after or while the reference map 512 is being updated, the signal processing resource 272 suppresses (Step 414) the dynamic range associated with each beam of the extant compressed B-scan 524. By way of explanation, three beams of the extant compressed B-scan will now be considered with reference to FIGS. 15(a) to (c). The sequence of amplitude samples within a beam is referred to as an ‘A-scan’. Referring to FIG. 15(a), a first A-scan 600 corresponds to a first beam, B₁, of FIG. 14. The first A-scan 600 has an average unity ratio amplitude following application of the ratio function mentioned above and corresponds to fluctuations caused by noise about the unity mean ratio amplitude, i.e. the first A-scan does not correspond to a non-stationary reflective target in the region 104 or a source of acoustic emissions. Turning to FIG. 15(b), a second A-scan 602 corresponds to a relatively high acoustic return signal from the new target 520 in respect of the second beam, B₂, of FIG. 14. In contrast, and referring to FIG. 15(c), a third A-scan 604 has a normalised amplitude slightly elevated above unity corresponding to the low amplitude transient emission captured by the third beam, B₃, of FIG. 14.

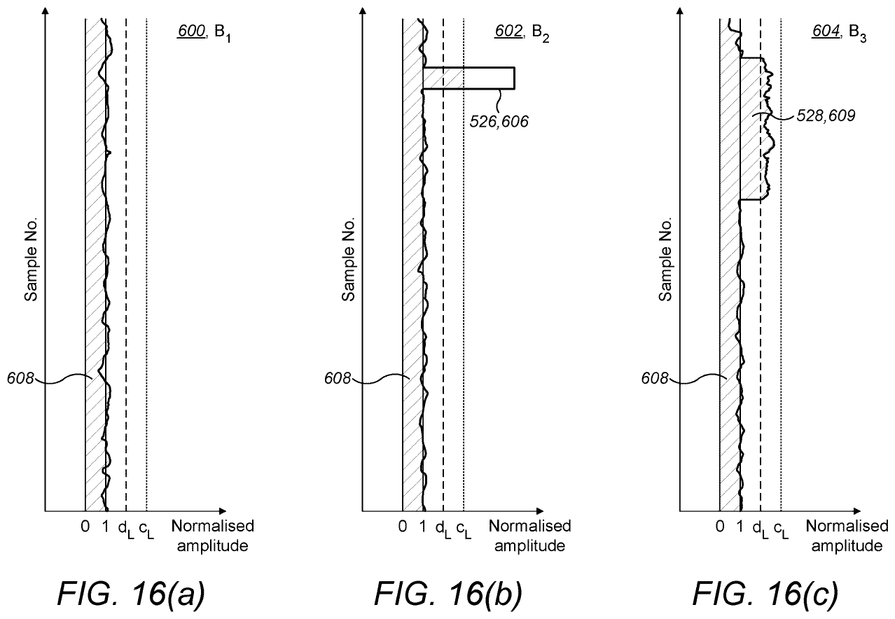

A-scans comprising acoustic energy arising from contacts that are not of interest from the perspective of passive detection, for example comprising reverberant energy originating from ensonification in respect of the active detection and processing chain 254, comprise energy levels that can distort the assessment of the A-scans as a result of a scoring process to be described later herein. Typically, the objective is to identify transient sources of acoustic emission that are relatively low level and have longer duration of emission than active reflections from non-stationary contacts. To ensure detection of such objects, a first step to perform is to apply a predetermined clipping level, C_{L}, to the A-scans of the extant compressed B-scan 524 in order to limit the effect of high energy reflections from non-stationary targets. Referring to FIGS. 16(a) to (c), which correspond respectively to FIGS. 15(a) to (c), the clipping level, C_{L}, is set relative to a predetermined detection level, di, that is also set. In this example, the detection level, di, is set between about 0.5 decibels and 10 decibels above the average normalised amplitude level (unity in this example) and the clipping level, C_{L}, is set between 0.5 decibels and 10 decibels above the detection level, du, for example between about 1 decibel and about 5 decibels, such as about 3 decibels.

Consequently, the signal processing resource 272 applies the clipping level, C_{L}, to each A-scan of the extant compressed B-scan 524. In relation to FIG. 16(a), as the first A-scan 600 has an average unity ratio and corresponds to fluctuations caused by noise about the unity mean normalised amplitude, no energy of the first A-scan 600 is limited by clipping. In contrast, the second A-scan 602 of FIG. 16(b) includes a limited range of consecutive samples of relatively high acoustic return signal 606 from the new target return 520 and comprises reflected energy exceeding the clipping level, C_{L}, and so all energy in respect of samples above the clipping level, C_{L}, is limited by the signal processing resource 272 to the clipping level, C_{L}, for example clipped samples 606. Turning to FIG. 16(c), the third A-scan 604, includes a range of consecutive samples corresponding to the low amplitude transient emission 609, which has a normalised amplitude slightly elevated above unity, but not exceeding the clipping level, C_{L}. As such, the signal processing resource 272 does not limit the energy of any of the samples of the third A-scan 604 to the clipping level, C_{L}. Thereafter, once the dynamic ranges of any A-scans of the extant compressed B-scan 524 have been suppressed (Step 414), it is necessary to filter the acoustic B-scan data that has been generated for passive detection of objects and so, following the above-described pre-processing of the acoustic B-scan, the signal processing unit 272 estimates (Step 416) integrated power level or energy 608 within each A-scan of the extant compressed B-scan 524. The pre-processing, inter alia, removes historic artefacts and mitigates the influence of reverberant energy in the B-scan. This scoring metric for energy content is employed in order to identify those A-scans 604, which include elevated levels of energy over longer periods of time as compared with A-scans 602, which include non-stationary localised active acoustic reflections or A-scans 600 including neither. The result of the estimates of the energy or power of each A-scan is a vector of N_{B} elements corresponding to the number of beams of the extant compressed B-scan 524, each element of the vector constituting a score in respect of each beam relating to the likelihood of a transient emission being present in the samples of that beam for the current measurement frame.

The passive signal processing module 308 then passes the vector of scores to the passive detection module 310 for filtering. In this regard, the passive detection module 310 applies a regional maximum filter to the scores of the vector in order to detect (Step 418) local maxima 700 (FIG. 17) amongst the scores of the vector, thereby assisting in the prevention of unwanted side-lobe based passive detections associated with non-covert (operationally irrelevant) sources of high amplitude acoustic emissions, for example ships manoeuvring in harbours, which have scores complying with a predetermined criterion, for example by comparison with the predetermined criterion, such as scores greater than a score threshold, S_{T}, to be described in further detail below, but which are not local maxima.

The scores of the vector that do not relate to regional maxima are zeroed, for example non-maxima scores 702 to leave local maxima as surviving scores. The surviving scores are then assessed relative to a score threshold, S_{T}, which is a function of a characteristic transient duration, to, the detection level, d_{L}, and the reduced complex sampling rate, F₀. In this regard, the transient duration, t_{D}, can be set to be around 0.5 seconds, but can depend upon the type of emission that is to be detected. The remaining non-zero scores of the vector that exceed the score threshold, S_{T}, constitute scores relating to candidate passive detections, i.e. the local maximum scores discounted for not exceeding the score threshold, S_{T}, are not interpreted as a potential source of non-reverberant energy emission, and the application of the score threshold, S_{T}, and assessment of scores exceeding the score threshold, S_{T}, is as follows.

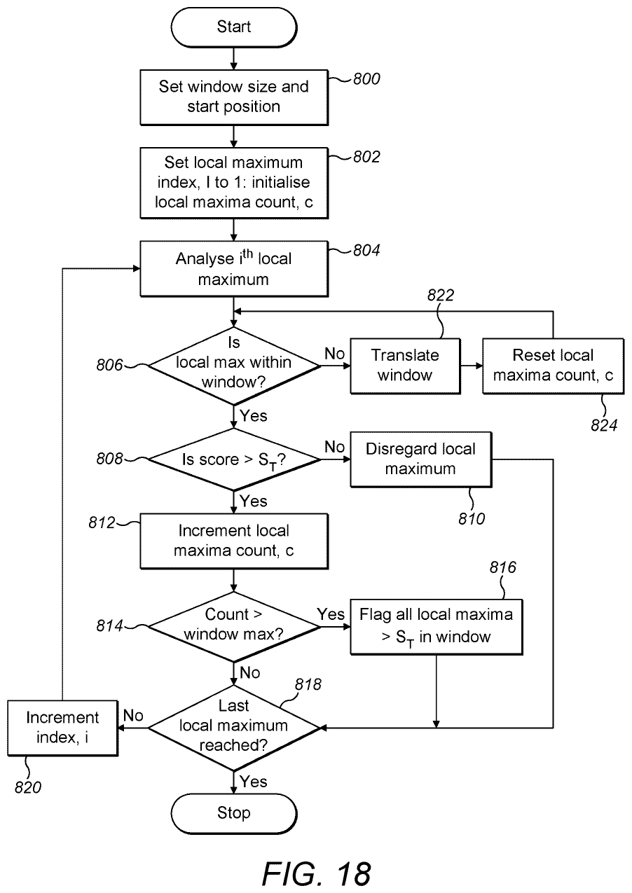

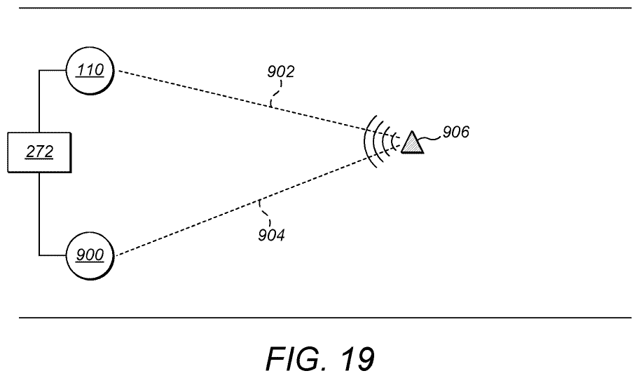

In order to identify beams corresponding to transient emission signals of interest and to ignore candidate passive detections associated with loud, non-covert contacts, a sliding box car filter is applied to the vector of scores, where the scores that are within a window of the filter and exceed the signal detection threshold, S_{T}, are counted. Referring to FIG. 18, the sliding filter comprises a count window within which scores exceeding the score threshold, S_{T}, are counted. The signal processing resource 272 therefore sets (Step 800) the size of the count window, which dictates the width of the count window in terms of number of beams, i.e. the number of elements of the scoring vector to be considered. The start position of the count window is also initialised to unity so that the leading edge of the count window is aligned with the start of the scoring vector. A beam local maximum index is set (Step 802) to unity and a beam count variable, c, is initialised to zero. The signal processing resource 272 then accesses and analyses (Step 804) the i^{th} local maximum identified following application of the regional maximum filter mentioned above. The signal processing resource 272 firstly determines (Step 806) whether the local maximum selected is within the count window as currently positioned. If the local maximum selected is within the count window, then the signal processing resource 272 determines (Step 808) whether the score that is the local maximum selected exceeds the score threshold, S_{T}. If the score threshold, S_{T}, has not been exceeded, the local maximum is disregarded (Step 810) and the signal processing resource 272 determines (Step 818) whether the last local maximum in the vector has been reached. However, if the score threshold, S_{T}, has been exceeded, the beam count, c, is incremented (Step 812) and the signal processing resource 272 determines (Step 814) whether the beam count exceeds a predetermined beam count maximum value. If the beam count exceeds the predetermined beam count maximum value, all the local maxima currently in the count window that exceed the score threshold, S_{T}, are flagged (Step 816), to identify them as non-compliant local maxima, and then the signal processing resource 272 proceeds to determine (Step 818) whether the last local maximum in the vector has been reached. In the event that the beam count does not exceed the predetermined beam count maximum value, the signal processing resource 272 proceeds directly to determining (Step 818) whether the last local maximum in the vector has been reached.

If the last local maximum in the vector has been reached, then the passive detection module 310 as implemented by the signal processing resource 272 provides the score vector index of the beam or the score vector indices of the beams, relating directly to the beam direction(s) associated with passive detections, that have not been flagged to the passive tracking module 312 in a like manner to that performed by the active detection module 304 delivering active detections to the active tracking module 306, although range information will not be discernible in this example. However, if the last local maximum in the vector has not been reached, the beam local maximum index, i, is incremented (Step 820) and the above steps of analysis of the scores within the count window (Steps 808 to 820) are repeated until the last local maximum in the vector has been reached. In addition to the above determination of whether scores exceed the score threshold, S_{T}, and counting local maxima with the count window, the count window is shifted during the counting process. In this regard, where the signal processing unit 272 determines (Step 806) that the index, i, of the selected local maximum is outside the count window, the signal processing unit 272 translates (Step 822) the count window by unity in the direction of increasing score vector index and the beam count, c, is reset (Step 824) to zero. Thereafter, the signal processing unit 272 again determines (Step 806) whether the index, i, of the selected local maximum is outside the count window and translation of the count window is repeated until the selected local maximum is within the count window. Once the selected local maximum is determined to be within the count window, the signal processing unit 272 continues to process the local maximum in the manner described above (Steps 808 to 820).

Using any suitable technique, for example the technique employed by an association filter module of the Sentinel IDS® system, the association filter module 314 communicates the A-scan data in respect of beams being tracked to the workstation 126. The workstation 126 displays sonar data, track data and alerts overlaid on a chart in respect of both active and passive contacts.

The skilled person should appreciate that the above-described implementations are merely examples of the various implementations that are conceivable within the scope of the appended claims. Indeed, this combined, contemporaneous, and co-located active/passive detection and tracking sonar could be deployed singly or as part of a multi-head underwater surveillance system. Referring to FIG. 19, it should be appreciated that the underwater intruder detection system 100 can comprise the sonar head 110, constituting a first sonar head, and a second sonar head 900, the first and second sonar heads 100, 900 being operably coupled to the signal processing resource 272 and implementing the passive and active detection and tracking described above. Similar to the above examples relating to the single sonar head 110, but now in respect of two sonar heads, the signal processing resource 272 generates first and second extant compressed B-scans respectively comprising a first transient signal 902 and a second transient signal 904 associated with an object 906 making acoustic emissions. In this example, the signal processing resource 272 uses both the first and second extant B-scans to calculate a correlation between the first and second transient signals 902, 904 so as then to triangulate a position in space in respect of the first and second transient signals in response to a high correlation between the first and second transient signals 902, 904 using first and second bearings of the first and second transient signals 902, 904. In this manner, a target can be localised in space solely with the passive detection and tracking processing chain 256 without the need for any active detection and tracking.

In the above examples relating to the use of multiple sonar heads, the one or more sonar heads can be static or one or more can be free to move. Where movement is permitted, each movable sonar head can comprise appropriate sensors to generate navigation data, for example attitude and position data. The navigation data can be used to apply compensation to the beam data of B-scans generated in respect of each movable sonar head, thereby mitigating correlation errors associated with movement of the sonar head(s).

In the examples set forth herein, it should be appreciated that the respective operating receive bandwidths of the active detection and tracking processing chain 254 and the passive detection and tracking processing chain 256 are the same. However, in other examples, the receive bandwidths of the respective processing chains 254, 256 can overlap or remain separate.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of pre-processing acoustic signals received from an ensonified region of an underwater environment for passive detection of an object in the underwater environment, the method comprising:
generating an acoustic B-scan in respect of a predetermined time frame;
selecting a temporal portion of the acoustic B-scan in accordance with a predetermined selection criterion;
compressing the selected temporal portion of the acoustic B-scan to provide a compressed acoustic B-scan;
applying a B-scan background mask to the compressed acoustic B-scan to suppress any historic reflectivity samples of the compressed acoustic B-scan and to provide an extant compressed acoustic B-scan; and
suppressing a dynamic range of the extant compressed acoustic B-scan.

2. The method according to claim 1, wherein selecting the temporal portion of the acoustic B-scan further comprises:
selecting the temporal portion of the acoustic B-scan in respect of a proportion of the predetermined time frame.

3. The method according to claim 2, wherein
the predetermined scan time extends between a temporally soonest time and a temporally latest time; and
the proportion of the predetermined time frame extends from an intermediate time to the temporally latest time, the intermediate time being located between the temporally soonest and latest times.

4. The method according to claim 1, wherein the acoustic B-scan comprises reverberant energy and non-reverberant energy, the selected temporal portion of the acoustic B-scan corresponding to a range in space proximal an end of a maximum reporting range in respect of the reverberant energy.

5. The method according to claim 1, wherein the selected temporal portion of the acoustic B-scan comprises a number of sequentially latter samples with respect to a duration of the predetermined time frame.

6. The method according to claim 1, wherein compressing the selected temporal portion of the acoustic B-scan further comprises:
selecting sets of samples in respect of each bearing of the selected temporal portion of the acoustic B-scan and respectively averaging each set of the selected sets of samples.

7. The method according to claim 1, wherein the B-scan background mask is a reference map of the region of the underwater environment.

8. The method according to claim 1, further comprising:
repeatedly updating the B-scan background mask from historic temporally filtered acoustic B-scans relating to the region of the underwater environment.

9. The method according to claim 1, wherein
the B-scan background mask is a record of an exponentially integrated acoustic B-scan history, the method further comprising:
constructing the B-scan background mask using consecutively windowed and compressed acoustic B-scans accumulated over an integration period of time.

10. The method according to claim 1, wherein compressing the selected temporal portion of the acoustic B-scan further comprises compressing the selected temporal portion of the acoustic B-scan according to a predetermined compression ratio, the predetermined compression ratio being configurable.

11. The method according to claim 1, wherein suppressing the dynamic range of the extant compressed acoustic B-scan further comprises:
clipping the extant compressed acoustic B-scan with respect to a predetermined clipping level.

12. The method as claimed in claim 11, further comprising:
a predetermined detection level for passive detection of an object in the region of the underwater environment; and
setting the predetermined clipping level above the predetermined detection level.

13. The method according to claim 1, wherein applying the B-scan background mask to the compressed acoustic B-scan further comprises:
applying a ratio function to the compressed acoustic B-scan and corresponding reflectivity data of the B-scan background mask.

14. The method of passive acoustic detection of an object in an ensonified region of an underwater environment, the method comprising:
pre-processing acoustic signals received from the ensonified region of the underwater environment using the method of pre-processing according to claim 1; and
analysing an extant A-scan in respect of a beam of the extant compressed acoustic B-scan of suppressed dynamic range to determine whether the extant A-scan relates to a source of non-reverberant energy of interest.

15. The method of performing active and passive acoustic detection substantially contemporaneously in time in respect of a region of an underwater environment, the method comprising:
ensonifying the region of the underwater environment;
performing the method of passive acoustic detection according to claim 14 to detect the source of non-reverberant energy in the underwater environment; and
performing active detection processing in respect of the acoustic B-scan generated for detecting a source of reverberant energy in the underwater environment of a predetermined category.
